(19) United States
(12) Patent Application Publication
(10) Pub. No.: US 2015/0019285 A1
(43) Pub. Date: Jan. 15, 2015

(54) REWARD SYSTEM FOR MANAGING A DIGITAL WORKFLOW

(71) Applicant: Apple, Inc., Cupertino, CA (US)

(72) Inventors: Brian D. Larson, East Palo Alto, CA (US); Ricardo Cortes, Los Gatos, CA (US); Aubrey Ness, San Francisco, CA (US)

(21) Appl. No.: 14/504,116

(22) Filed: Oct. 1, 2014

Related U.S. Application Data
(63) Continuation of application No. 12/240,800, filed on Sep. 29, 2008.

(51) Int. Cl. G06Q 10/06

(52) U.S. Cl. CPC G06Q 10/06316
USPC 705/7.26

(57) ABSTRACT

A system and method for allowing content providers to manage aspects of a distributor's digital workflow is disclosed. The system is effective to receive priority flags and associate the flags with items submitted by the content provider making the priority designation. Those items flagged for priority can be queued for priority processing. The total number of priority flags or requests can be limited by the rate at which items can be processed. The limited nature of the priority requests can make the priority flags valuable. The system and method can leverage that value to encourage desired conduct by awarding priority flags to content providers that comply with a stated policy.

### CROSS-REFERENCE TO RELATED APPLICATIONS

This application is a continuation of U.S. patent application Ser. No. 12/240,800, filed on Sep. 29, 2008, which is incorporated by reference in its entirety for all purposes herein.

### TECHNICAL FIELD

The present disclosure relates to a method and system for managing a digital workflow and in particular for accepting a limited number of priority designations from suppliers to prioritize the workflow.

### INTRODUCTION

At some level, businesses of all types need to manage the priority of certain tasks. Perhaps certain types of tasks are more important than others and thus, these tasks always receive priority. For example, in a client oriented business, completing tasks related to client deliverables always receive the highest priority, while tasks required for the day-to-day maintenance of the business might receive a lower priority.

More difficult is choosing which tasks, chosen from a group of similar tasks, should be given priority. For example, using an assembly line as a conceptual model, work pieces come onto the assembly line and tasks are performed on the work piece, and thus, the completed work piece is removed from the assembly line. The task performed is similar for each object and is repeated over and over. Continuing with the example, consider next that, in some instances, a work piece coming onto the assembly line needs to be taken out of turn. To advance the work piece out of turn, a person must receive the information that the work piece must be advanced, physically move the work piece forward in line, pause the normal assembly line flow to fit the prioritized work piece into the line for processing and then return operations to normal.

While advancing the work piece is conceptually simple, this example illustrates that it can be appreciated that it take a good deal of human resources to accelerate a prioritized work piece through the system. The example becomes increasingly more complicated, both conceptually and in terms of resources, as more and more work pieces require special treatment.

The above example holds in the case of digital workflows. Instead of an assembly line, a digital workflow managing program is used to move work pieces forward in a queue. In this example, the digital workflow managing program can be as simple as an ordered list. Even though the list is digital, advancing a work piece in the list still involves human interaction to force the system to work in a way that it was not designed to—taking a work piece out of order. A technician still must receive information that a work piece needs to be advanced out of turn and must physically move the item to a different location in the list.

In a supplier-distribution environment, it is often not the technician that is choosing to prioritize the processing of a particular work piece. Thus, the technician is receiving communications from someone, perhaps a customer or supplier, requesting prioritization of a particular work piece. This communication process itself is very time consuming and in some cases could require employment of a separate technician just to receive these communications an act on them. Accordingly, there is a need for a system that can receive prioritization requests from a third-party such as a customer or supplier and appropriately prioritize the work piece in the digital workflow.

Allowing customers and suppliers to request special treatment is not without its own problems. In many cases, accepting these prioritization requests is critical to running a superior business and penalizing customers or suppliers for these requests is not practical. However, any free system is subject to abuse which, if unchecked, will cause the system to break down. Practically, any system that receives more priority requests than it can treat with priority will fail. If the system is so abused that every item is to receive priority, no item will actually be given the priority it requires. Therefore, there is a need to design a priority request system for a digital workflow that will not be subject to service-for-free abuse.

### SUMMARY

A system and method is described which addresses the shortcomings of digital workflows. In one embodiment, the digital workflow can be for processing media items, such as songs, videos, movies, audio books, images, or any other media item. In such a system, content providers provide content to the system which requires quality control editing before the media items can be made available for purchase. In the presently described system and method, content providers may select a limited number of media items for priority processing.

In one embodiment, only a set number of media items can be given priority processing over the course of a given time period, for example, a week. The number of available priority requests is therefore limited, making these requests valuable. By virtual of their value, priority requests can be awarded to certain content providers that for compliance with distributor preferred policies. One such policy can be a defined by a style guide delimiting proper naming and capitalization procedures. In such an instance, a reward system can be created which encourages content providers to submit content that requires less quality control processing, and thus less resources, before the media item is available to the public.

In another embodiment, the present disclosure describes a method of allowing suppliers to prioritize items in a distributor's digital workflow. The method includes receiving, from content providers, items to be processed in a rate-limited workflow and accepting, from the content providers, priority flags respectively associated with some of the items. The number of priority flags available to each content provider is constrained based, at least in part, on the rate at which the workflow can process received items. Such constraints can be the rate at which a technician can provide quality control processing for the items, or any other rate-limiting step. The method further includes queuing the received items for processing. The queue is organized into a priority portion including items associated with respective priority flags, and a non-priority portion for items not associated with a priority flag. The items in the priority portion of the queue are processed before the items in the non-priority portion, that is, processed with priority.

The number of priority flags available can be replenished after some predetermined time period, for example each week. Flags can be assigned using on any number of methods such as a reward for compliance with an item submission policy. Flags can also be given to preferred providers without basis in any objective criteria.

In at least one preferred embodiment, the described method is particularly useful for processing media items such as, but not limited to music tracks, music videos, audio books, movies, photographs, recorded radio programs and music albums.

Also disclosed is a device for carrying out the foregoing method. The device includes a communication interface configured to receive, from content providers, items to be processed in a rate-limited workflow. The device also includes a storage device configured to store the items to be processed which are received via the communication interface. The communication interface is further configured to receive, from the content providers, priority flags. The priority flags are respectively associated with some of the items, and the number of priority flags available to each content provider is constrained based at least in part on the rate at which the workflow can process received items. The device further includes a signal processor in signal communication with the storage device and the communication interface. The signal processor is further configured to process items into a queue of received items for processing. The queue organized is into a priority portion including items associated with respective priority flags, and a non-priority portion for items not associated with a priority flag.

Also described herein is a computer readable medium having computer readable code for allowing suppliers to prioritize items in a distributor's digital workflow, the computer readable code which causes a computer to receive, from content providers, items to be processed in a rate-limited workflow and accept, from the content providers, priority flags respectively associated with some of the items. The number of priority flags available to each content provider is constrained based at least in part on the rate at which the workflow can process received items. The computer readable medium further causes the computer to queue the received items for processing. The queue is organized into a priority portion including items associated with respective priority flags, and a non-priority portion for items not associated with a priority flag.

Also described is a method for a distributor to accept content from content providers. The method includes allocating priority request rights to each of a plurality of content providers. The amount of priority requests allocated is based at least on an expected number of priority requests that can be processed during a determined time interval. The method further includes accepting items of content, for distribution, submitted by any of the content providers and priority requests associated with the items. As the content providers make such priority requests, their respective allocations of requests are decremented. Based on the priority requests, the intake processing of any submitted item associated with a priority request made within the priority request rights are prioritized.

Additional features and advantages of the concepts disclosed herein are set forth in the description which follows, and in part will be obvious from the description, or may be learned by practice of the described technologies. The features and advantages of the concepts may be realized and obtained by means of the instruments and combinations particularly pointed out in the appended claims. These and other features of the described technologies will become more fully apparent from the following description and appended claims, or may be learned by the practice of the disclosed concepts as set forth herein.

### BRIEF DESCRIPTION OF THE DRAWINGS

In order to best describe the manner in which the above described embodiments are implemented, as well as define other advantages and features of the disclosure, a more particular description is provided below and is illustrated in the appended drawings. Understanding that these drawings depict only exemplary embodiments of the disclosed technology and are not therefore to be considered to be limiting in scope, the examples will be described and explained with additional specificity and detail through the use of the accompanying drawings in which:

FIG. 1 illustrates an example system embodiment;

FIG. 2 illustrates an example system embodiment;

FIG. 3 illustrates an example method embodiment;

FIG. 4a illustrates a example graphical user interface with priority flag fields;

FIG. 4b illustrates the graphical user interface of FIG. 4a without priority flag fields;

FIG. 5a illustrates a example graphical user interface with priority flag fields;

FIG. 5b illustrates the graphical user interface of FIG. 4a without priority flag fields;

FIG. 6a illustrates a example graphical user interface with priority flag fields;

FIG. 6b illustrates the graphical user interface of FIG. 4a without priority flag fields; and

FIG. 7 illustrates an example grade board embodiment.

### DETAILED DESCRIPTION

Various embodiments of the disclosed methods and arrangements are discussed in detail below. While specific implementations are discussed, it should be understood that this is done for illustration purposes only. A person skilled in the relevant art will recognize that other components, configurations, and steps may be used without parting from the spirit and scope of the disclosure.

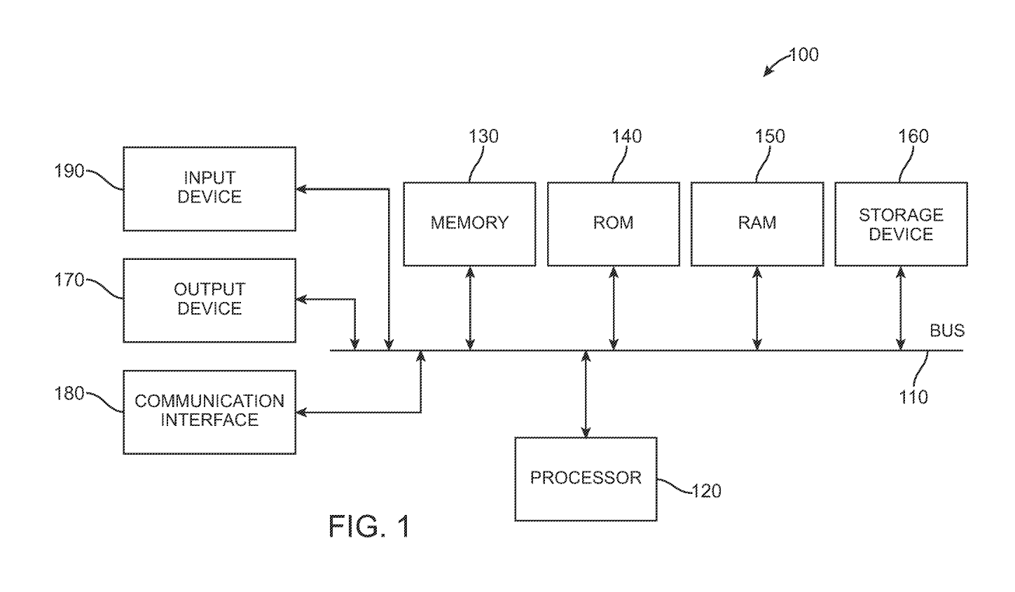

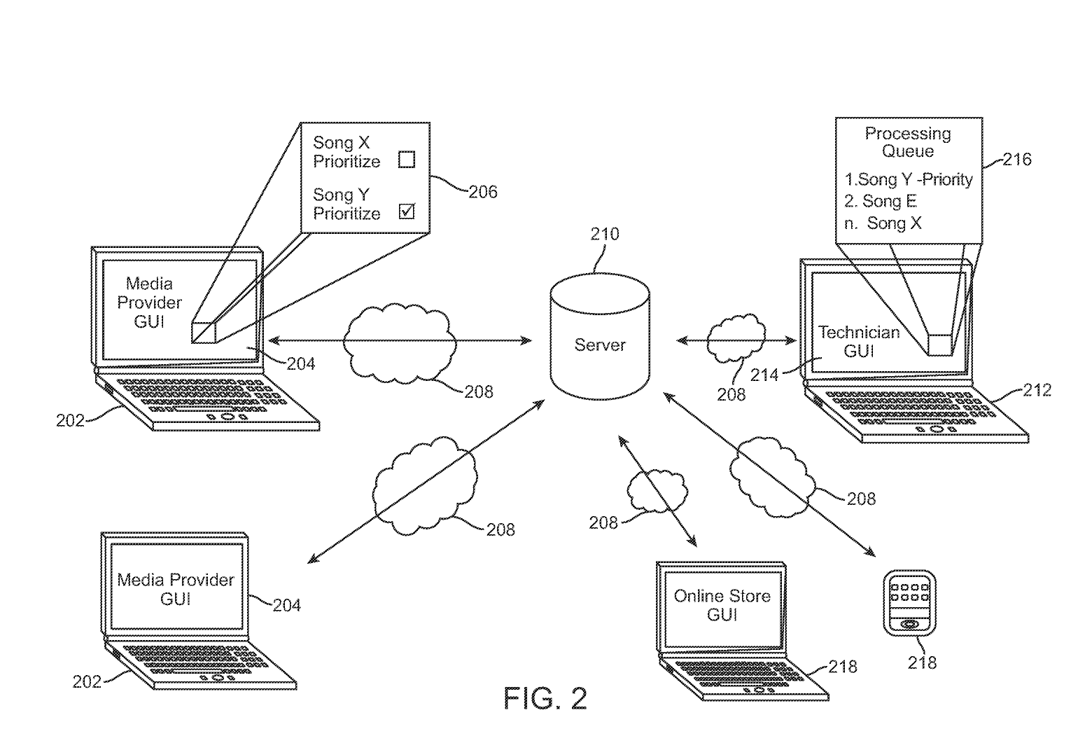

With reference to FIG. 1, an exemplary system includes a general-purpose computing device 100, including a processing unit (CPU) 120 and a system bus 110 that couples various system components including the system memory such as read only memory (ROM) 140 and random access memory (RAM) 150 to the processing unit 120. Other system memory 130 may be available for use as well. It can be appreciated that the system may operate on a computing device with more than one CPU 120 or on a group or cluster of computing devices networked together to provide greater processing capability. The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices such as a hard disk drive 160, a magnetic disk drive, an optical disk drive, tape drive or the like. The storage device 160 is connected to the system bus 110 by a drive interface. The drives and the associated computer readable media provide nonvolatile storage of computer readable instructions, data structures, program modules and other data for the computing device 100. In one aspect, a hardware module that performs a particular function includes the software component stored in a tangible computer-readable medium in connection with the necessary hardware components, such as the CPU, bus, display, and so forth, to carry out the function. The basic components are known to those of skill in the art and appropriate variations are contemplated depending on the type of device, such as whether the device is a small, handheld computing device, a desktop computer, or a large computer server.

Although the exemplary environment described herein employs a hard disk, it should be appreciated by those skilled in the art that other types of computer readable media which can store data that is accessible by a computer, such as magnetic cassettes, flash memory cards, digital versatile disks, cartridges, random access memories (RAMs), read only memory (ROM), a cable or wireless signal containing a bit stream and the like, may also be used in the exemplary operating environment.

To enable user interaction with the computing device 100, an input device 190 represents any number of input mechanisms, such as a microphone for speech, a touch-sensitive screen for gesture or graphical input, keyboard, mouse, motion input, speech and so forth. The input may be used by the presenter to indicate the beginning of a speech search query. The device output 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on the disclosed methods and devices operating on any particular hardware arrangement and therefore the basic features may easily be substituted for improved hardware or firmware arrangements as they are developed.

For clarity of explanation, the illustrative system embodiment is presented as comprising individual functional blocks (including functional blocks labeled as a “processor”). The functions these blocks represent may be provided through the use of either shared or dedicated hardware, including, but not limited to, hardware capable of executing software. For example the functions of one or more processors presented in FIG. 1 may be provided by a single shared processor or multiple processors. (Use of the term “processor” should not be construed to refer exclusively to hardware capable of executing software.) Illustrative embodiments may comprise microprocessor and/or digital signal processor (DSP) hardware, read-only memory (ROM) for storing software performing the operations discussed below, and random access memory (RAM) for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits.

The computing device described above is particularly useful for managing a digital workflow. In one exemplary use of the system, content providers supply items to an online store such as Apple Inc.'s ITUNES online store and designate which of those items should be treated as priority items.

Before the items can be published to the online store and made available for purchase by consumers, employees of the online store must perform a quality review of the items. Such a review creates a bottleneck for publishing new items to the online store which results in a backlog of items waiting for review.

Certain items may require faster publishing to the online store. For example, if a item is anticipated to be highly successful, it will be important to make that content available for consumers to purchase immediately. Accordingly, the system provides content providers with the ability to advance selected items for more immediate processing.

One example of such a system is illustrated in FIG. 2. Providers access the server 210 of the online store using a work station computer 202 to view a graphical user interface 204. As will be described in greater detail below, providers can upload items of content, such as music tracks, music albums, audio books, music videos, movies, radio programs, PODcasts, photos or any other media item to the server of the online store. The provider can also view the items they have uploaded as depicted in graphical user interface screen 206. The provider can choose to prioritize items for accelerated quality intake processing by using one of their allocated priority requests or priority flags. For example in screen 206, the provider has selected to prioritize Song Y.

The provider's work station computer can communicate with the online store server 210 using any communication medium 208 such as, but not limited to, over a modem, Ethernet, Internet, 802.11 series communications, or a cellular connection.

The server 210 is not limited to one device; it can be any number of units that perform separate or related functions. The server 210 can receive and store items transmitted by providers and can also receive information such as priority requests or data representative of a priority flag. The items can be stored in a queue for processing by a technician. The technician can connect to the sever 210 using a workstation computer 212 and access the queue of items awaiting processing using a graphical user interface 214. The graphical user interface 214 may be the same or similar to graphical user interface 204, but in a preferred embodiment, graphical user interface 214 is a different interface specific to the needs of the technician. Screen 216 illustrates one example of the type of content that the technician may see using graphical user interface 214. Screen 216 shows a processing queue containing songs received from multiple media providers. Song Y, has been flagged for priority processing and thus, it is at the top of the list. The technician will act on this file first.

Once the technician has performed the appropriate processing of the item, the song is available to be published to the online store. Once the song has been published to the online store, users can access the online store server 210 via a workstation 218 and purchase the item.

It should be appreciated that the items provided by the content provider need not be delivered via an electronic connection. In some embodiments, the content provider can provide tangible items, by shipping, to a distributor. In such embodiments, the distributor can still provide an interface by which the content provider can choose to prioritize the processing of selected individual items. For example, the content provider can mail files contained on media, such as a compact disc or DVD, to the distributor. The distributor can upload the files for the content provider and associated the files with the content provider's account, for their management.

The processing required should not be limited by any examples provided herein. It should be appreciated that the processing can be any type of processing required or desired to be carried out by a distributor. In a preferred embodiment the processing includes quality control processing or intake processing.

Intake processing can be any processing such as that required in receiving an item and preparing it for sale. For example, items may require processing for formatting metadata to meet a style guide. A particular value of legitimate, for purchase, online stores of digital multi-media is the quality of metadata associated with the multi-media files. For example, while a particular music track could be illegally downloaded for free, that file could contain data errors. Such errors can include, but are not limited to poor file conversion or file quality leading to sound skips, distortion, static or any number of undesirable characteristics. Other errors include incorrect file names or metadata which can result in the downloading of one song while intending to download another. Such problems are mostly eliminated by legitimate online media providers, which check the file names, metadata and sometimes even the quality of the file conversion before publishing the file for purchase on an online store. Such processing is one preferred type of processing embodied in the present technology.

While an on-line store is used as a preferred example herein, it should be appreciated that the present technology is not limited to digital stores and is equally applicable to stores selling tangible products, whether online or physical stores.

While the described system allows content providers to prioritize their content for expedited processing, the system does not necessarily permit all content providers to have access to this feature. It can be appreciated that this service can be offered only to the most favored content providers, or content providers that provide large quantities of content, or providers chosen by any other criteria. In such instances, it is not desirable to alert all content providers of the existence of the service. Therefore, in one embodiment, only certain content providers can see fields related to priority flagging in the graphical user interface.

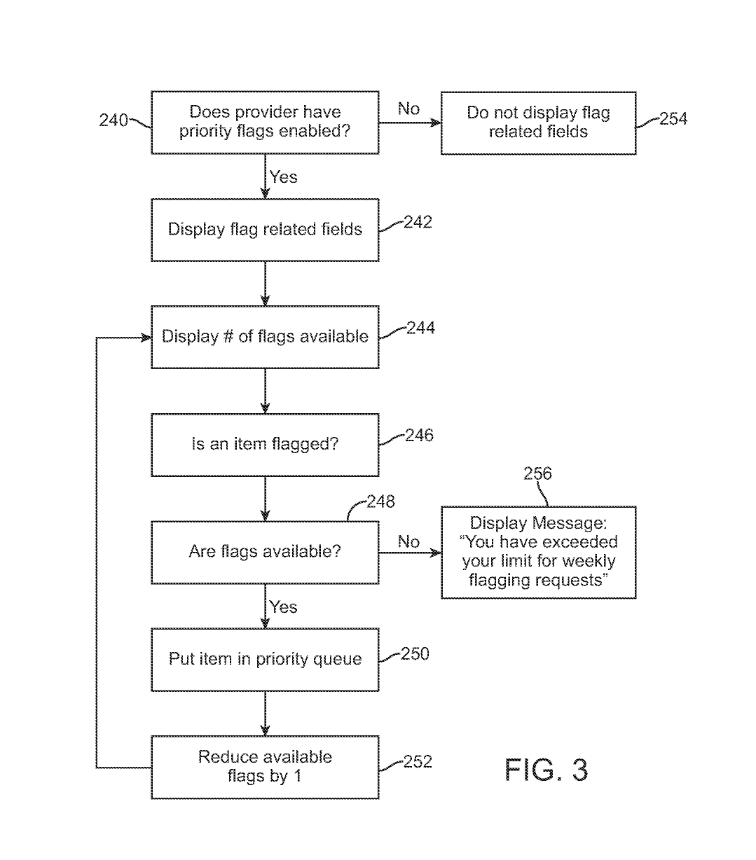

FIG. 3 illustrates one example of how the provider's graphical user interface can function. In step 240 the system can check to see if the provider has the priority flagging feature enabled. Priority flagging can be enabled based on automatic or manual methods. For example, a technician can enable priority flagging within the system by interacting with an interface. In such an example, a decision can be made by the distributor's personnel to enable the feature for selected distributors. Alternatively, the priority flagging system itself can make the decision. For example the system can be configured to give priority flagging capabilities to content providers that provide a certain amount of content per week.

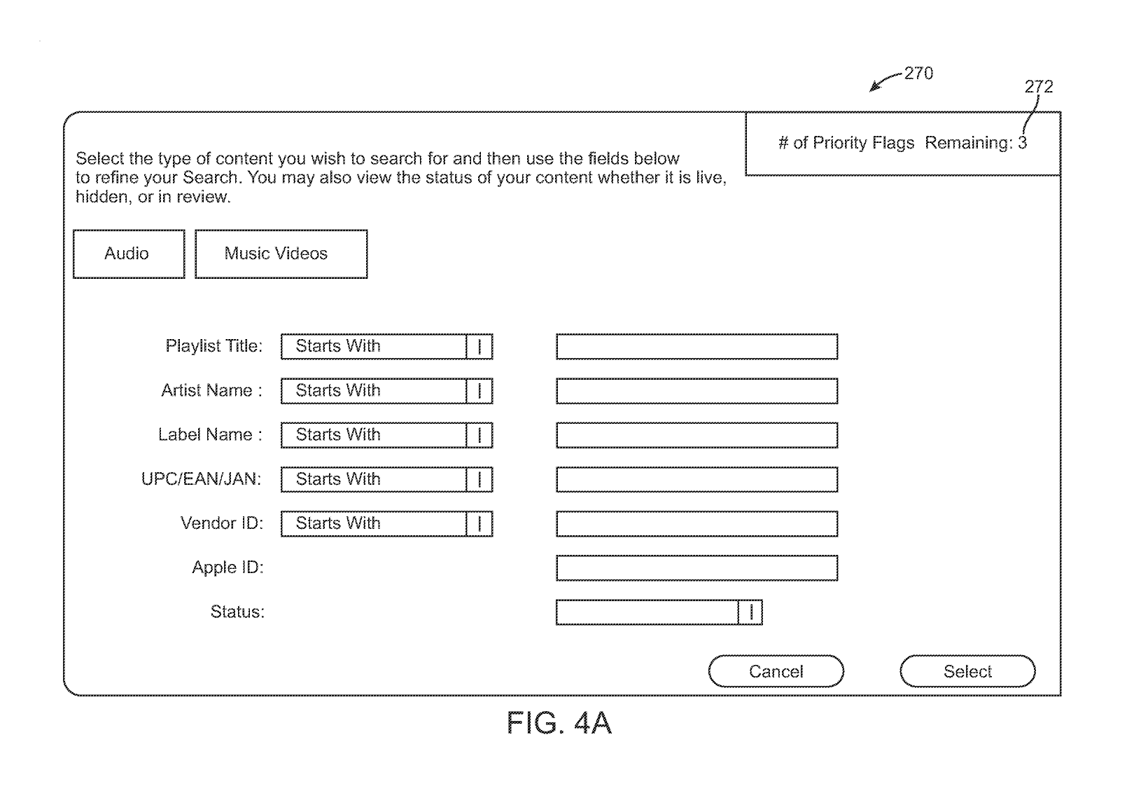

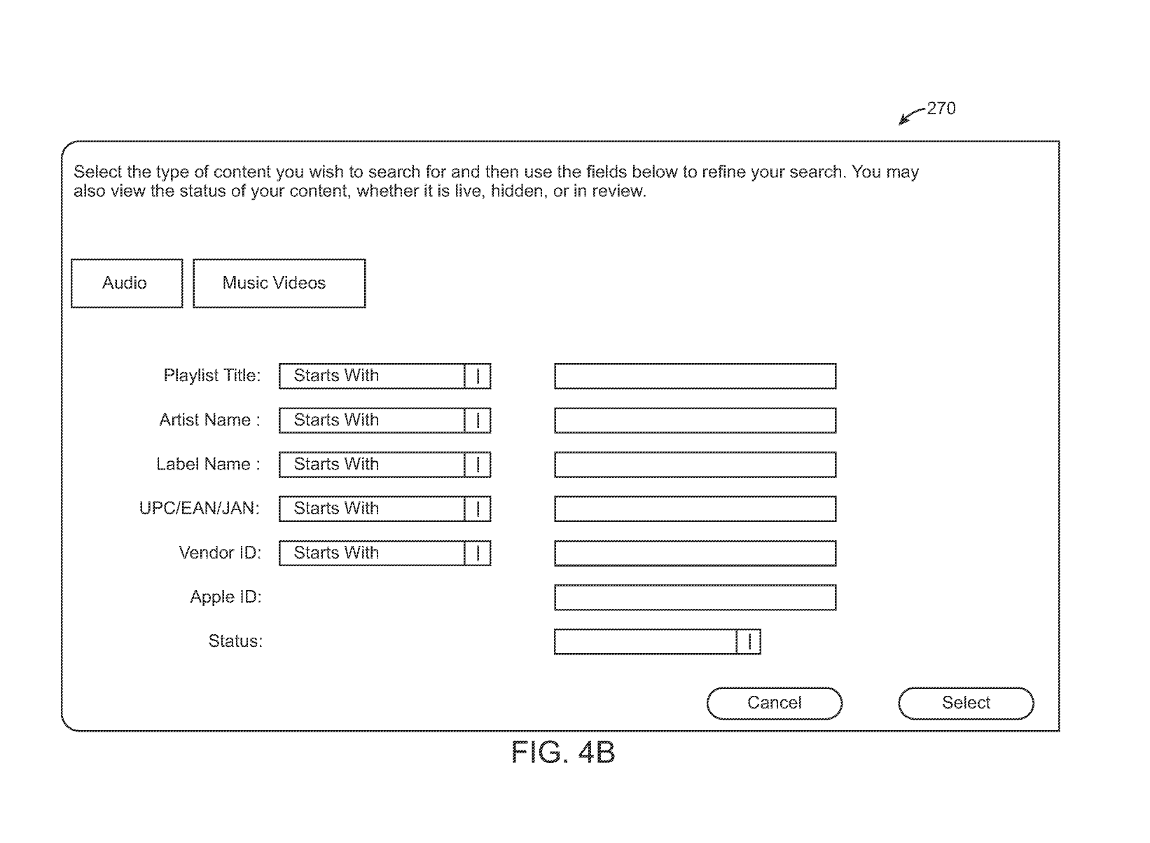

If the step 240 reveals that priority flagging is not enabled for that content provider, the method will proceed to step 254, and will not display priority flagging related fields. However, if step 240 reveals that priority flagging is enabled for that content provider, the method will proceed to step 242 and will display priority flag related fields. Steps 254 and 242 are best illustrated by comparing FIGS. 4-6. FIGS. 4a, 5a and 6a illustrate example content provider interfaces with flag related fields displayed, while FIGS. 4b, 5b and 6b. illustrate the same interfaces without flag related fields displayed.

FIG. 4a is an example search interface 270, enabling content providers to search for audio or music video media items that they have already provided to the system. The interface displays a field 272 which displays the number of priority flags available to the content provider.

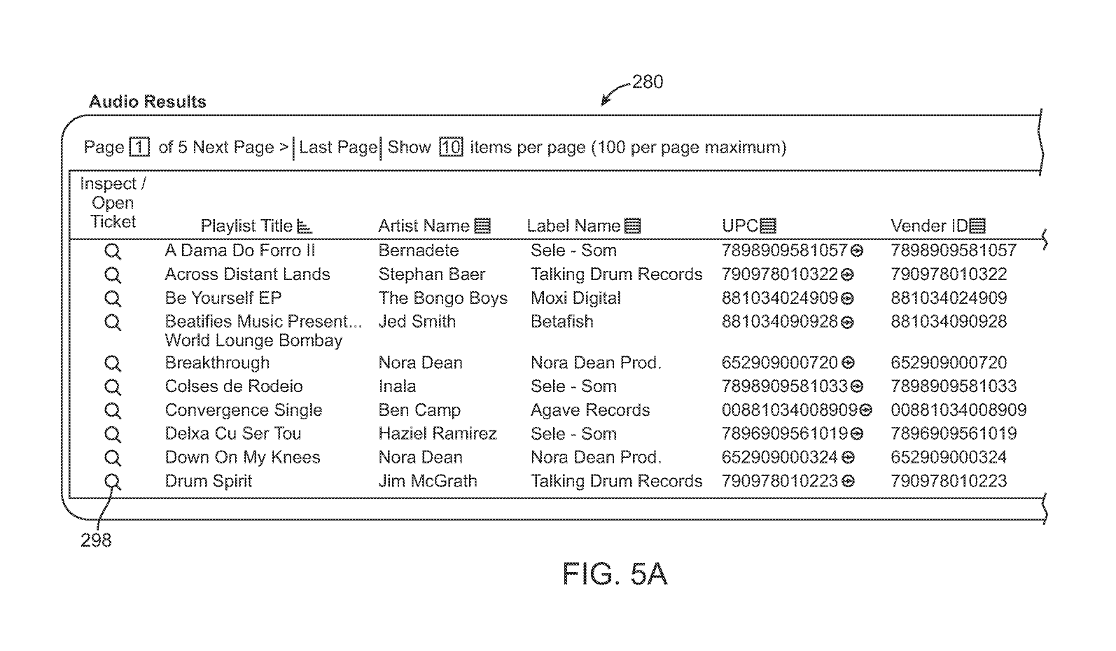

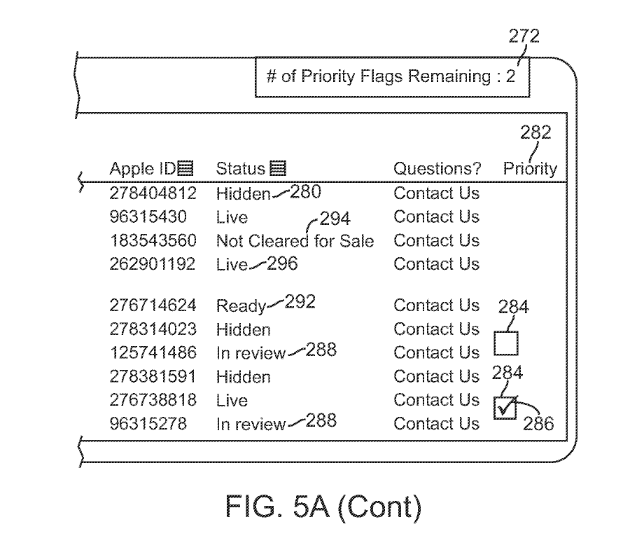

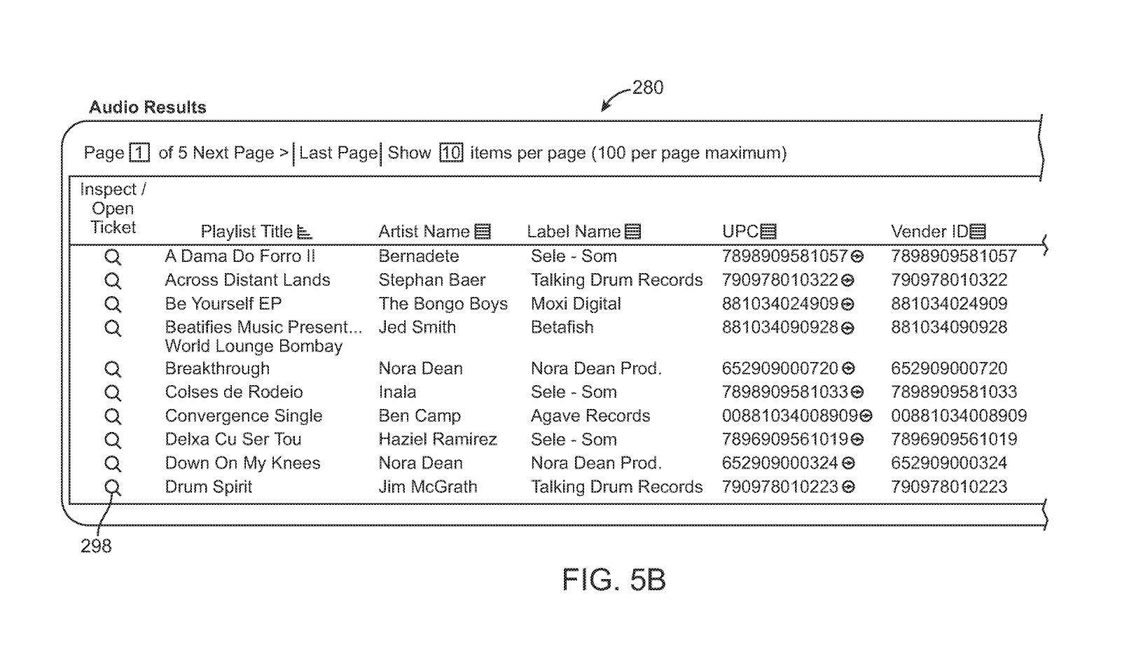

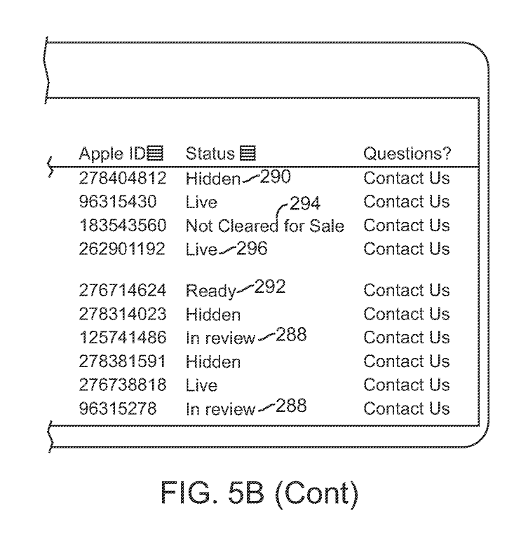

FIG. 5a is an example search results screen 280 that can be generated in response to a search performed on the interface 270. Just as in screen 270, field 272 is present representing the number of priority flags or priority requests available to the provider. As shown in this figure, field 272 shows only two priority flags available, which represent a reduction of one priority flag from screen 270. The reduction is in response to the content provider's use of one priority flag 286 in field 284.

Search results screen 280 includes a priority column 282. Within that column, fields 284 for setting priority flags are available for all items for which priority processing can be selected. Fields 284 should only be made available for items that are waiting for processing. In the interface illustrated in FIG. 5a, only those items having a status “in review” 288 are waiting for processing and thus, only these items are associated with fields 284. Other status fields such as “hidden” 290, “ready” 292, “not cleared for sale” 294, and “live” 296 indicate that the item is not waiting for processing. Items with this status either have already been processed, or do not need processing because they are not presently intended to be published to the online store.

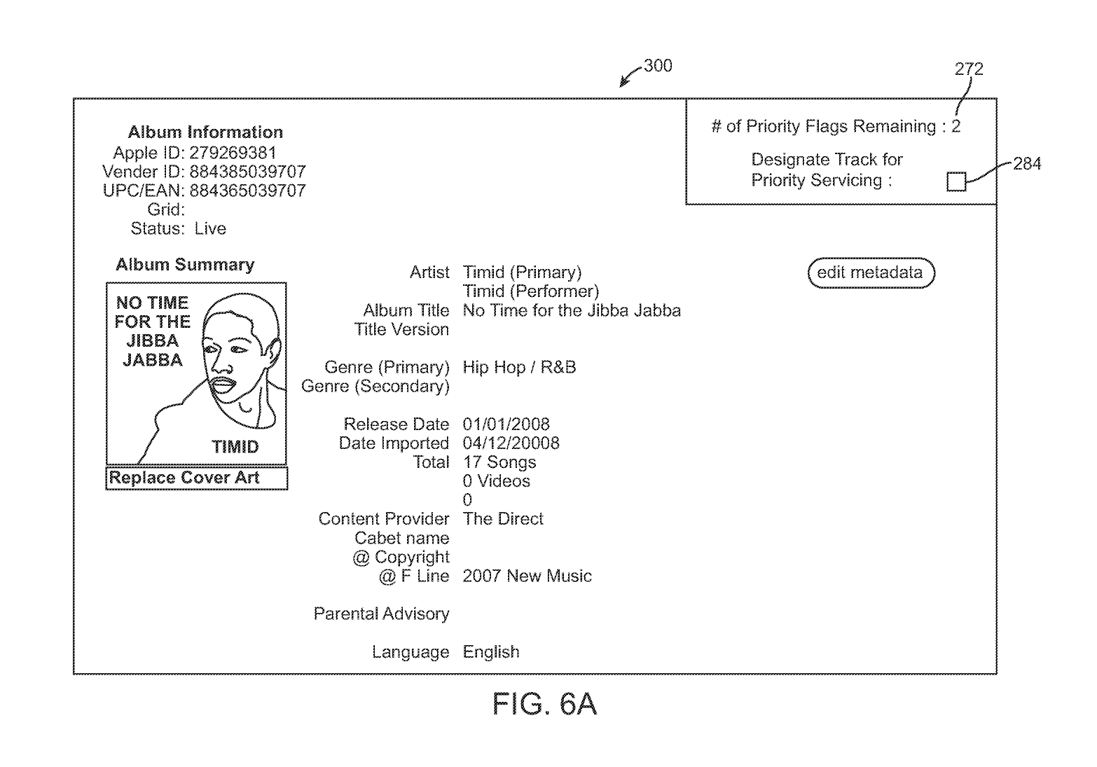

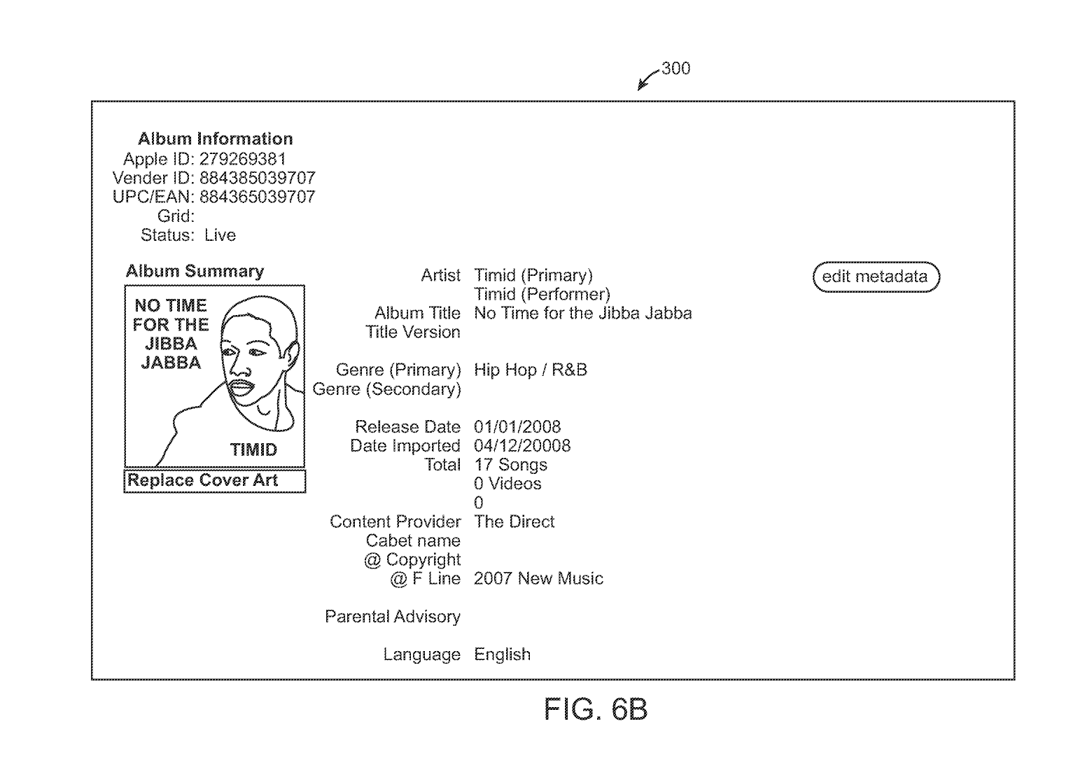

Search results screen 280 can also include a link 298 to another interface screen which displays items in greater detail. While the illustrated example shown in FIG. 6a, show a detail view 300 for a music album, it should be appreciated that a similar page could be displayed for individual audio tracks, or any other item. Detail view 300 also shows field 272 displaying the number of priority flags available to the provider and field 284 for setting priority flags.

Content providers should have the ability to unselect items flagged for priority processing, however it might be desirable to only provide this ability for a limited time. Field 284 may be selected by setting flag 286 or maybe unselected at any time before the item undergoes processing. In one embodiment, a flagged field can be unselected at any time within a set time period.

It will be appreciated the content providers will log on to the server using a graphical user interface. Each login can initiate a new session, while logging out, timing out or closing the interface will terminate the session. In some embodiments, a content provider will only be able to unselect a previously flagged priority field until terminating the session.

Returning to FIG. 3, step 244 displays the number of priority flags available to the content provider within a field configured to display such information in a graphical user interface. The method also checks if any items are newly flagged in step 246 and if so further checks to see if any flags are available to the content provider in step 248. If no flags are available, step 256 displays a message informing the user. One example of such a message is: “You have exceeded your limit for weekly flagging requests.” In such an instance the flagged field can be unselected, or in other embodiments, the priority field will not even accept a flag in the field if not enough requests are available.

Assuming the content provider has enough flags available, the method proceeds to step 250 wherein the item is put into the priority portion of the queue and the number of flags available to the content provider is reduced by 1 in step 252. The updated number of available flags can now be shown in step 244.

The queue can be constructed in any number of ways. In one embodiment, the queue can be comprised of more than one queue. For example the queue can be made up a priority queue which contains priority items and a non-priority queue which contains all other items. In other embodiments, the queue is a singular queue having a priority portion and a non-priority portion. In another embodiment, some items are first placed into the non-priority queue and then later removed and added to the priority portion of the queue. The queue can be created anew each hour or each day, or the queue can be rearranged based on the receipt of priority requests or flags.

While most of the present disclosure refers to priority flags, it should be appreciated that any means of designating priority is encompassed by this term including but not limited to priority requests.

It should further be appreciated that although content providers can deliver content to the distributor electronically, via a data upload, it is also conceived that content providers can deliver content in a tangible form and the data can be put into the system by the distributors technicians.

As will be appreciated, the above described embodiments solve at least one problem in managing a digital workflow. It allows the party making the decision to prioritize an item in the workflow to order or rearrange the workflow without involving an intermediary. This solution can save untold amounts of time by creating efficiencies that are better applied to other steps in the process. For example, the time saved could be used to actually process the items in the workflow, thus making the workflow more productive.

However allowing third-parties to make decisions about whether to receive additional services, such as preferred treatment, without a cost to the third-parties can be subject to abuses. Thus, some limit on the third-parties ability to demand these extra services must be put in place.

In one embodiment, the number of priority flags available for use is limited. The total number of flags or the pool of available priority flags for all users should not exceed the number of items that can actually be given priority treatment. In a preferred example, the total pool of available priority flags is based on an estimate of the number of items a distributor's personnel can actually process with priority in a given time period. However, the total pool could be a smaller amount, reduced by an arbitrary amount or by a more systematic method.

In some instances, it can be desirable to have a total number of priority flags be greater in number than the number of items that can actually be processed with priority in a given time period. For example, in some cases, experience with the system may reveal that the total number of available priority flags are never actually used, thus extra bandwidth will exist for processing items with priority. In this instance it can be desirable to have a total pool that is greater than the actual number of items that can be treated with priority. For example, this can be carried out by basing the total number of priority flags on the average of statistical usage of the flags.

In another example, the total pool of priority flags can be varied based on time, such as months, weeks, seasons, etc. It will be appreciated the experience with the system will reveal that in certain months of season, less bandwidth for priority processing is available. Whether due to personnel absences or otherwise, these can be used in calculating the total pool of priority flags. Likewise, experience can reveal that all priority requests are used the first week of every month, but not the second week and this type of data can also be used to calculate the available number of priority requests.

In a preferred embodiment, the total number of priority flags can be divided amongst two or more content providers. The number of priority flags allotted to each content provider can be determined randomly, split evenly, or determined based in part on some other factor.

In one embodiment, the default number of priority flags to be awarded can be zero. In this embodiment priority flags can be awarded to selected content providers. These content providers can be preferred, or provide more content, better content, adhere to system guidelines better than their peers, have negotiated for the privilege of making priority requests or can be selected at random.

In another embodiment, the number of flags awarded to content providers is varied based on preferred behavior exhibited by the content providers. In such a way, the priority flags serve as rewards for compliance with distributor policies. For example, in the case of an online music store, wherein the items must have their metadata edited to meet certain requirements set forth in a style guide, priority flags can be awarded to those content providers that submit their content in a form that already meets the standards set forth in the style guide. In this way, content providers are encouraged to submit items that already comply with the style guide. In doing so, the distributor gains the benefit of reduced processing time for each item.

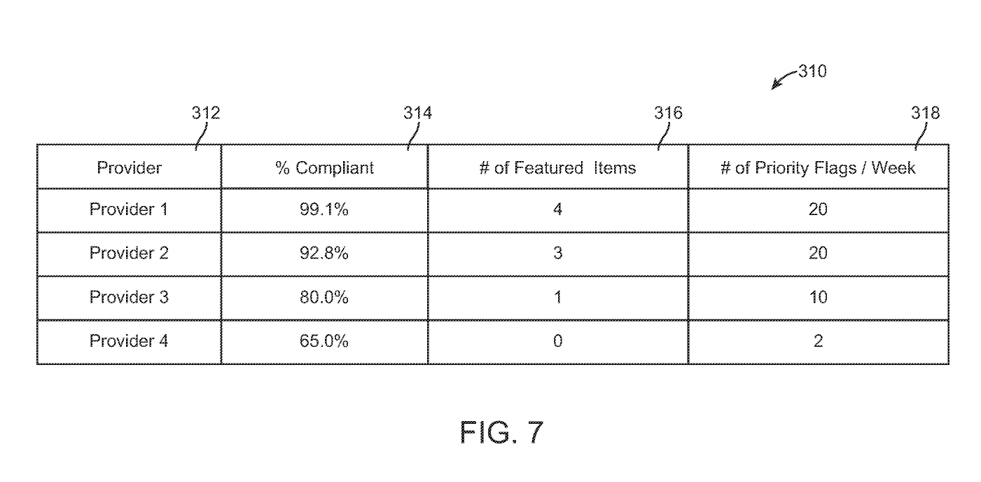

In one example of this embodiment, the priority flags can be used to drive competition amongst content providers, further encouraging the content providers to submit items in compliance with the style guide. One method that can help encourage such competition is illustrated in FIG. 7. FIG. 7 shows a grade board 310 which can be published to show each content provider how they compare to other content providers. Column 312 lists the different providers and column 314 displays the level of compliance with the style guide for each provider. This level of compliance can be measured in any objective way, but in at least one embodiment, a record of the number of items that are not compliant is recorded and a percentage of items that are complaint or are not compliant can be displayed in column 314. Another method of evaluating the level of compliance can be to measure the average time it takes to process a item for each provider. The shorter the amount of time to process the item, the more complaint the items are likely to be. Of course many other ways of measuring compliance with any policy is considered to be within the scope of the presently described concept.

Columns 316 and 318 illustrate awards or favorable treatment given to highest ranking providers. In this example column 316 illustrate the number of featured items or advertising spots in the online store that a provider might receive. Featured items are controlled by the online store and are often negotiated for, but in the context of this system, they can serve as rewards for favored behavior. Column 318 illustrates the number of priority flags per week that a content provider receives. The higher the provider's ranking, the more priority flags the content provider is awarded.

Compliance with a style guide or some other stated policy need not be the only way of determining favorable treatment. Such beneficial actions can be a part of the decision, whether by the system or a technician, to award favorable treatment. Further the described concept can be useful for encouraging any desired behavior, not just compliance with a published manual.

Embodiments within the scope of the present disclosure may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures that perform particular tasks or implement particular abstract data types. Computer-executable instructions, associated data structures, and program modules represent examples of the program code means for executing steps of the methods disclosed herein. The particular sequence of such executable instructions or associated data structures represent examples of corresponding acts for implementing the functions described in such steps. Program modules may also comprise any tangible computer-readable medium in connection with the various hardware computer components disclosed herein, when operating to perform a particular function based on the instructions of the program contained in the medium

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

Communication at various stages of the described system can be performed through a local area network, a token ring network, the Internet, a corporate intranet, 802.11x wireless signals, fiber-optic network, radio or microwave transmission, etc. Although the underlying communication technology may change, the fundamental principles described herein are still applicable.

The various embodiments described above are provided by way of illustration only and should not be construed to limit the claims. Those skilled in the art will readily recognize various modifications and changes that may be made to the present disclosure without following the example embodiments and applications illustrated and described herein, and without departing from the true spirit and scope of the present disclosure. Accordingly, only the appended claims and their legal equivalents should define technology, rather than any specific examples given.

1. A computer implemented method comprising:
determining a quantity of priority flags to assign to each of a plurality of content providers, the quantity being determined with respect to each individual content provider based on a specified criteria, wherein the total quantity of all the priority flags assigned is correlated to a maximum system volume; and
assigning to each of a plurality of content providers a quantity of priority flags according to the determination.

2. The computer implemented method of claim 1, further comprising:
receiving, from the plurality of content providers, items to be processed, wherein some of the items are associated with a priority flag; and
processing the items associated with the priority flag before the items not associated with the priority flag.

3. The computer implemented method of claim 1, wherein the specified criteria is that the quantity of priority flags assigned to an individual content provider is increased when items received from the individual content provider comply with a style guide.

4. The computer implemented method of claim 1, wherein the specified criteria is that the quantity of priority flags assigned to an individual content provider is increased when items received from the individual content provider require less processing time.

5. The computer implemented method of claim 1, wherein the maximum system volume is a rate in which received items can be processed.

6. The computer implemented method of claim 1, wherein the maximum system volume is based on a statistical usage of priority flags.

7. The computer implemented method of claim 6, wherein the maximum system volume is greater than a rate in which received items can be processed when the plurality of content providers statistically do not use all assigned priority flags.

8. The computer implemented method of claim 7, wherein the maximum system volume is related to a number of assigned priority flags that were unused.

9. A system comprising:
a processor configured to determine a quantity of priority flags to assign to each of a plurality of content providers, the quantity being determined with respect to each individual content provider based on a specified criteria, wherein the total quantity of all the priority flags assigned is correlated to a maximum system volume, and further configured to assign to each of a plurality of content providers a quantity of priority flags according to the determination.

10. The system of claim 9, further comprising:
a communication interface configured to receive, from a content provider, items to be processed, wherein a number of the items up to the quantity of priority flags assigned to the content provider are associated with a priority flag and items associated with the priority flag are processed before the items not associated with the priority flag, the number being less.

11. The system of claim 9, wherein the specified criteria is that the quantity of priority flags assigned to an individual content provider is increased when items received from the individual content provider comply with a style guide.

12. The system of claim 9, wherein the specified criteria is that the quantity of priority flags assigned to an individual content provider is increased when items received from the individual content provider require less processing time.

13. The system of claim 9, wherein the maximum system volume is a rate in which received items can be processed.

14. The system of claim 9, wherein the maximum system volume is based on a statistical usage of priority flags.

15. The system of claim 14, wherein the maximum system volume is greater than a rate in which received items can be processed when the plurality of content providers statistically do not use all assigned priority flags.

16. The system of claim 15, wherein the maximum system volume is related to a number of assigned priority flags that were unused.

17. A non-transitory computer readable medium having computer readable code stored thereon for causing a computing device to perform a method comprising:
determine a quantity of priority flags to assign to each of a plurality of content providers, the quantity being determined with respect to each individual content provider based on a specified criteria, wherein the total quantity of all the priority flags assigned is correlated to a maximum system volume; and
assign to each of a plurality of content providers a quantity of priority flags according to the determination.

18. The non-transitory computer readable medium of claim 17, the method further comprising:
receive, from the plurality of content providers, items to be processed, wherein some of the items are associated with a priority flag; and
process the items associated with the priority flag before the items not associated with the priority flag.

19. The non-transitory computer readable medium of claim 17, wherein the specified criteria is that the quantity of priority flags assigned to an individual content provider is increased when items received from the individual content provider comply with a style guide.

20. The non-transitory computer readable medium of claim 17, wherein the specified criteria is that the quantity of priority flags assigned to an individual content provider is increased when items received from the individual content provider require less processing time.

21. The non-transitory computer readable medium of claim 17, wherein the maximum system volume is a rate in which received items can be processed.

22. The non-transitory computer readable medium of claim 17, wherein the maximum system volume is based on a statistical usage of priority flags.

23. The non-transitory computer readable medium of claim 22, wherein the maximum system volume is greater than a rate in which received items can be processed when the plurality of content providers statistically do not use all assigned priority flags.

24. The non-transitory computer readable medium of claim 23, wherein the maximum system volume is related to a number of assigned priority flags that were unused.
